(19) United States
(12) Patent Application Publication
(10) Pub. No.: US 2011/0171343 A1
(43) Pub. Date: Jul. 14, 2011

(54) TWO-FLAVORED ADDITIVE FOR ANIMAL FEED, AND METHOD FOR PREPARING SAME

(75) Inventors: Jean-Philippe Meunier, Cessy (FR); Christelle Raulet, Thyez (FR); David Bravo, Yverdon-les-Bains (CH)

(73) Assignee: Pancosma Societe Anonyme pour I'Industrie des Produits Biochimiques

(21) Appl. No.: 13/063,574

(22) PCT Filed: Aug. 18, 2009
(86) PCT No.: PCT/IB09/06571

§ 371 Date: Mar. 11, 2011

(30) Foreign Application Priority Data
Sep. 16, 2008 (FR) 0805064

(51) Int. Cl. A23K 1/18; A23K 1/00; A23K 1/16; A23L 1/00

(52) U.S. Cl. 426/2; 426/96; 426/97; 426/302

(57) ABSTRACT

The invention relates to an additive, particularly for promoting food intake and the growth of animals such as piglets. Said additive is in the form of granules, each including: a core that includes at least one compound selected from taste modifiers, taste enhancers, and flavors; and a coating that includes at least two flavors. The invention also relates to a method for preparing such an additive.

The invention relates to an additive intended, notably, for promoting food intake and growth in animals such as piglets. The invention also relates to a method of preparation of said additive.

### BACKGROUND OF THE INVENTION

Nowadays, farmers seek the optimum yield from their stock rearing, in particular maintaining or increasing consumption in order to maintain growth. Use of additives is indispensable for this.

There are numerous flavor modifiers or enhancers on the market for increasing consumption, and research is constantly being conducted for finding additives with better and better performance, intended to stimulate the animal's appetite, so that it consumes the maximum amount of food, and therefore grows more quickly.

### SUMMARY OF THE INVENTION

The main aim of the present invention is therefore to propose a novel feed additive that is intended to promote food intake and growth in animals.

This new additive was obtained by the inventors, surprisingly, by the application of somatesthesia. This term denotes thermal, tactile, kinesthesic, proprioceptive and trigeminal (relating to the trigeminal nerve) chemical sensitivity. To activate this sensitivity, the inventors therefore developed novel technology combining at least two compounds among flavor modifiers, flavor enhancers and flavor ingredients, in order to obtain two successive sensations at the moment of dissolution of the product in saliva. Thus, the final effect obtained is an increase in palatability of the feeds consumed by the animal.

Concretely, the feed additive according to the invention is in the form of granules, each of which comprises:
a core comprising at least one compound selected from flavor modifiers, flavor enhancers and flavor ingredients and
a coating comprising at least two flavor ingredients.

The feed additive according to the invention is not medicinal. It combines the benefits of flavor modifiers, flavor enhancers and flavor ingredients.

In fact, once the additive is in the animal's mouth, the coating is dissolved by the animal's saliva, releasing the core, which amplifies the first sensation and produces two successive sensations at the moment of dissolution of the product in the saliva.

The invention also relates to a method of preparation of a feed additive according to the invention that comprises the following stages:
a first stage of obtaining cores in solid form each comprising at least one compound selected from flavor modifiers, flavor enhancers and flavor ingredients; and
a second stage of formation of coatings around the cores obtained previously, said coatings each comprising at least two flavor ingredients.

Other characteristics and advantages of the invention will now be described in detail in the following account.

### DETAILED DESCRIPTION OF THE INVENTION

a) Additive According to the Invention

The feed additive according to the invention is in the form of granules, each of which comprises:
a core comprising at least one compound selected from flavor modifiers, flavor enhancers and flavor ingredients; and
a coating comprising at least two flavor ingredients.

The flavor modifiers are agents that supply at least one taste among the following: sweet, salt, sour, bitter, umami.

As flavor modifier supplying a sweet taste, we may mention sugar, saccharin or a salt thereof, aspartame, acesulfame-K, cyclamates, stevioside and glucono-δ-lactone ((3R,4S,5S,6R)-3,4,5-trihydroxy-6-(hydroxymethyl)tetrahydro-2H-pyran-2-one). Of course, it is possible to use a combination of at least two of these compounds. Preferably, saccharin is used.

As flavor modifier supplying a salt taste, we may mention ammonium chloride, calcium chloride, magnesium chloride, potassium chloride, or sodium chloride, and magnesium sulfate.

As flavor modifier supplying a sour taste, we may mention acetic acid, adipic acid, citric acid, fumaric acid, gluconic acid, glucono-δ-lactone, lactic acid, maleic acid, phosphoric acid, food-grade pH regulators, tartaric acid.

As flavor modifier supplying a bitter taste, we may mention caffeine, amygdalin, quinine, salicilin, theophylline, theobromine.

As flavor modifier supplying an umami taste, we may mention monosodium glutamate, amino acids, peptides, proteins and ribotides.

A flavor enhancer is a substance which, without having a pronounced flavor of its own, does not modify the flavor but increases the intensity of olfacto-gustatory perception.

The flavor enhancer can be selected from glutamates, guanylates, inosinates, ribonucleotides, amino acids, neohesperidin dihydrochalcone, kokumi, glycyrrhizin, glycyrrhizinates, thaumatin and its derivatives.

The flavor ingredients are food-grade flavor ingredients as defined, notably, by European Directive 88/388/EEC which classes food-grade flavor ingredients in 5 families: nature, nature-identical, artificial, from transformation and smoked.

There are at least two works of reference listing flavor ingredients: “Perfume and Flavor Chemicals”, by Steffen Actander and “Fenaroli's Handbook of Flavor Ingredients”, by George A. Burdock.

As flavor ingredient for the core or the coating, we may mention vanillin (3-methoxy-4-hydroxybenzaldehyde), ethyl vanillin (3-ethoxy-4-hydroxybenzaldehyde), maltol, ethyl maltol, anethole, methyl salicylate, eucalyptus and menthol.

The flavor ingredients are generally incorporated in a matrix constituted of a material usually employed as matrix, such as maltodextrin, native or modified starch, gum arabic, guar gum, a lecithin, alginic acid or derivatives thereof, agar, carob bean gum, xanthan gum, sorbitol or derivatives thereof, mannitol, glycerol, a pectin, an alginate, a carrageenan, cellulose or a derivative thereof, a saponin, a hydrogenated fat, a glyceride of fatty acid or derivatives thereof or a mixture of at least two of these compounds.

Of course, it is possible to use a combination of these compounds, in any proportions.

### Proportions

In the feed additive according to the invention:
the core preferably represents from 0.5 to 60%, preferably from 40 to 60% of the total weight of the additive;
the coating preferably represents from 99.5 to 40%, preferably from 60 to 40% of the total weight of the additive.

With regard to the core, it preferably comprises:
from 5 to 100%, in particular 10 to 100%, by weight, of at least one compound selected from flavor modifiers, flavor enhancers and flavor ingredients as defined previously; and
the complement to 100% of a matrix as defined previously.

And among the compounds of the core other than the matrix if present, there can be:
from 0 to 100%, preferably 50 to 100 wt. %, of one or more flavor modifier(s);
from 0 to 50%, preferably 0 to 20 wt. o, of one or more flavor enhancer(s);
from 0 to 100%, preferably 50 to 100 wt. %, of one or more flavor ingredient(s);
the sum of the percentages of these compounds of the core other than the matrix being equal to 100%.

With regard to the coating, it preferably comprises:
from 5 to 100%, in particular from 10 to 100 wt. %, of at least two flavor ingredients as defined previously; and
the complement to 100% of a matrix as defined previously.

An emulsifier can optionally be added to the matrix of the core or of the coating. In this case, its percentage is included in the percentage of the matrix.

The feed additive according to the invention can be used directly in animal feeding at an average dose of 70 to 500 g/t.

b) Method According to the Invention

1st Stage

The first stage of manufacture of the feed additive according to the invention consists of obtaining particles, each comprising, optionally incorporated in a matrix, the compound or compounds selected from flavor modifiers, flavor enhancers and flavor ingredients.

For this, it is possible to use any method enabling a powder to be obtained.

For example, it is possible to prepare a solution, generally aqueous, containing the compound or compounds, the optional matrix and optionally a conventional emulsifier. Next, the solution is sprayed to form a powder constituted of the compound or compounds and of the optional matrix as well as any optional emulsifier.

Preferably, the technique used is granulation by fluidized-bed spraying. The advantage of this technique is that it offers the possibility of developing relatively spherical and homogeneous microparticles permitting the application, in a second stage, of a coating of good quality.

2nd Stage

The second stage consists of coating the microparticles (cores) obtained at the end of the first stage.

The coating is made from the flavor ingredients and, if necessary, a matrix as described previously.

The whole is generally dissolved or made into an emulsion in water (optionally by means of a conventional emulsifier or any compound possessing emulsifying power) and then sprayed onto the microparticles, which preferably have been suspended beforehand in a fluidized bed. The final product thus obtained is in the form of coated granules whose core/coating distribution is uniform and whose proportion should therefore be constant in the feed.

### Example

### Formulation

A formulation was prepared using a core constituted of saccharin and a coating constituted of a mixture of two flavor ingredients, anethole and methyl salicylate.

The coating was constituted of the mixture of flavor ingredients incorporated in a matrix based on a mixture of maltodextrin and modified starch.

### 1. Raw Materials

Anethole (1-methoxy-4-(1-propenyl)benzene) (Ernesto, Ventos, Barcelona, Spain) was used as aromatic molecule with sweet taste and as active principle (non-medicinal) in combination with methyl salicylate (methyl ortho-hydroxybenzoate) (Ernesto, Ventos, Barcelona, Spain) used as aromatic molecule supplying a fresh note and nonmedicinal active principle.
Maltodextrin Granadex 20 (Avebe veendam, the Netherlands) and modified starch (Hicap 100, National Starch, Germany) are used as excipients (matrix) for fluidized-air-bed granulation.

Finally, saccharin (Atlantic Chimical, China) is used as sweetener for the particle core.

### 2. Preparation of the Microparticles

### 2.1 Preparation of Formulation F1

In a first stage, the saccharin is dissolved and then it is granulated by spraying in a fluidized-air-bed of the Procell 5 type (Glatt GmbH, Weimar, Germany) according to the conditions described in Table 2. The particle size to be obtained is fixed between 25 and 500 μm.

TABLE 1
Composition of the saccharin solution

| | Amount | Solid |
|---|---|---|
| Compound | (g) | (%) |
| Saccharin | 400 | 100.00 |
| Water | 600 | |
| Total | 1000 | 100.00 |

TABLE 2
Parameters of granulation of formulation
F1 in a fluidized-air-bed of the Procell
5 type (Glatt GmbH, Weimar, Germany)

| | Bottom |
|---|---|
| Parameters | spraying |
| Air flow rate m³/h | 100-140 |
| Product temperature (° C.) | 27-36 |
| Nozzle (mm) | 1 |
| Air pressure for | 2.5 |
| spraying (bar) | |
| Spraying rate | 15 |
| (g/min) | |

### 2.2. Preparation of Formulation F2

Coating of the composition F1 is carried out in a fluidized-air-bed of the Procell 5 type using, as coating, an emulsion (Table 3) based on aromatic molecules.
In a 1st stage, the maltodextrin and modified starch are dissolved in water. The solution of anethole and methyl salicylate is then added slowly, stirring vigorously (using an Ultraturax or a homogenizer under pressure). The emulsion thus obtained is then used as coating solution in a fluidized-air-bed with the operating conditions described in Table 4. Coating is carried out up to 65.6% (w/w) of the final product, i.e. until formulation F2 is obtained (Table 5).

TABLE 3
Composition of the coating formulation

| Compound | Solution (%) | Solid (%) |
|---|---|---|
| Maltodextrin | 13.74 | 34.34 |
| Hicap 100 | 13.74 | 34.34 |
| Propylene glycol | 2.00 | 5.00 |
| Anethole | 10.00 | 25.00 |
| Methyl salicylate | 0.53 | 1.32 |
| Water | 60.00 | 0.0 |
| Total | | 100.00 |

TABLE 4
Parameters for coating (65.6%, w/w)
of formulation F2 in a
fluidized-air-bed of the Procell 5
type (Glatt GmbH, Weimar, Germany)

| | Bottom |
|---|---|
| Parameters | spraying |
| Air flow rate m³/h | 120-300 |
| Product temperature (° C.) | 50-65 |
| Nozzle (mm) | 1.2 |
| Nozzle temperature (° C.) | 70 |
| Air pressure for | 2.5 |
| spraying (bar) | |
| Product temperature (° C.) | 48-50 |
| Spraying rate | 56-86 |
| (g/min) | |

TABLE 5
Composition of formulation F2

| | Percentage |
|---|---|
| Compound | by weight |
| Formulation F1 | 34.4 |
| Maltodextrin | 22.5 |
| Hicap 100 | 22.5 |
| Propylene Glycol | 3.3 |
| Anethole | 16.4 |
| Methyl salicylate | 0.9 |
| Total | 100 |

### c) Uses

Tests on animals showed that this two-flavored feed additive according to the invention increases consumption and growth in piglets.

1. An additive for animal feed that is in the form of granules, each granule comprising:
a core comprising at least one compound selected from flavor modifiers, flavor enhancers and flavor ingredients; and
a coating comprising at least two flavor ingredients.

2. The additive for animal feed as claimed in claim 1, wherein the flavor modifier of the core is a compound supplying a sweet taste.

3. The additive for animal feed as claimed in claim 2, wherein the compound supplying a sweet taste is selected from the group comprising sugar, saccharin and salts thereof, aspartame, acesulfame-K, cyclamates, stevioside and glucono-δ-lactone ((3R,4S,5S,6R)-3,4,5-trihydroxy-6-(hydroxymethyl)tetrahydro-2H-pyran-2-one).

4. The additive for animal feed as claimed in claim 3, wherein the compound supplying a sweet taste is saccharin.

5. The additive for animal feed as claimed in claim 1, wherein the flavor modifier of the core is a compound supplying a salt taste.

6. The additive for animal feed as claimed in claim 5, wherein the compound supplying a salt taste is selected from the group comprising ammonium chloride, calcium chloride, magnesium chloride, potassium chloride, or sodium chloride and magnesium sulfate.

7. The additive for animal feed as claimed in claim 1, wherein the flavor modifier of the core is a compound supplying a bitter taste.

8. The additive for animal feed as claimed in claim 7, wherein the compound supplying a bitter taste is selected from the group comprising caffeine, amygdalin, quinine, salicilin, theophylline, theobromine and derivatives of these compounds.

9. The additive for animal feed as claimed in claim 1, wherein the flavor modifier of the core is a compound supplying a sour taste.

10. The additive for animal feed as claimed in claim 9, wherein the compound supplying a sour taste is selected from the group comprising acetic acid, adipic acid, citric acid, fumaric acid, gluconic acid, glucono-δ-lactone, lactic acid, maleic acid, phosphoric acid, food-grade pH regulators, tartaric acid.

11. The additive for animal feed as claimed in claim 1, wherein the flavor modifier of the core is a compound supplying an umami taste.

12. The additive for animal feed as claimed in claim 11, wherein the compound supplying an umami taste is selected from the group comprising monosodium glutamate, amino acids, peptides, proteins and ribotides.

13. The additive for animal feed as claimed in claim 12, wherein the compound supplying an umami taste is monosodium glutamate.

14. The additive for animal feed as claimed in claim 1, wherein the flavor enhancer of the core is selected from the group comprising glutamates, guanylates, inosinates, ribonucleotides, amino acids, neohesperidin dihydrochalcone, kokumi, glycyrrhizin, glycyrrhizinates, thaumatin and its derivatives.

15. The additive for animal feed as claimed in claim 1, wherein the optional flavor ingredient or ingredients of the core and the flavor ingredients of the coating are selected from vanillin (3-methoxy-4-hydroxybenzaldehyde), ethyl vanillin (3-ethoxy-4-hydroxybenzaldehyde), maltol, ethyl maltol, anethole, methyl salicylate, eucalyptus and menthol and mixtures of at least two of these compounds.

16. The additive for animal feed as claimed in claim 1, wherein the flavor modifier(s) and/or flavor enhancer(s) and/or flavor ingredient(s) of the core are incorporated in a matrix.

17. The additive for animal feed as claimed in claim 1, wherein the flavor ingredients of the coating are incorporated in a matrix.

18. The additive for animal feed as claimed in claim 16, wherein the matrix comprises at least one material selected from the group comprising maltodextrin, native or modified starch, gum arabic, guar gum, a lecithin, alginic acid or derivatives thereof, agar, carob bean gum, xanthan gum, sorbitol or derivatives thereof, mannitol, glycerol, a pectin, an alginate, a carrageenan, cellulose or a derivative thereof, a saponin, a hydrogenated fat, a glyceride of fatty acid or derivatives thereof or a mixture of at least two of these compounds.

19. The additive for animal feed as claimed in claim 1, wherein:
the core constitutes from 0.5 to 60% of the total weight of the additive;
the coating constitutes from 99.5 to 40% of the total weight of the additive.

20. The additive for animal feed as claimed in claim 1, wherein the core comprises:
from 5 to 100% of at least one compound selected from flavor modifiers, flavor enhancers and flavor ingredients as defined previously; and
the complement to 100% of a matrix.

21. The additive for animal feed as claimed in claim 1, wherein, in the core, the compounds other than the optional matrix comprise:
from 0 to 100%, preferably 50 to 100 wt. % of one or more flavor modifier(s);
from 0 to 50%, preferably 0 to 20 wt. % of one or more flavor enhancer(s);
from 0 to 100%, preferably 50 to 100 wt. % of one or more flavor ingredient(s);
the sum of these compounds of the core other than the matrix being equal to 100%.

22. The additive for animal feed as claimed in claim 1, wherein the coating comprises:
from 5 to 100% of at least two flavor ingredients as defined previously; and
the complement to 100% of a matrix.

23. A feed for farm animals, comprising 70 to 500 g/t of additive as claimed in claim 1.

24. A method of promoting an animal's food intake and performance, comprising feeding the animal the additive for animal feed according to claim 1.

25. The method as claimed in claim 24, wherein the animal is a piglet.

26. A method of preparation of an additive for animal feed as claimed in claim 1, comprising:
a first stage of formation of cores, each comprising at least one compound selected from flavor modifiers, flavor enhancers and flavor ingredients; and
a second stage of formation of coatings around the cores obtained previously, said coatings each comprising at least two flavor ingredients.

27. The method as claimed in claim 26, wherein the first stage comprises granulation by fluidized-bed spraying.

28. The method as claimed in claim 26, wherein, in the first stage, the flavor modifier(s) and/or flavor enhancer(s) and/or flavor ingredient(s) is/are made into a solution, which is then sprayed to form cores.

29. The method as claimed in claim 26, wherein the second stage comprises preparation of a solution of a material intended to form a matrix, then addition of the flavor ingredients to this solution in order to form an emulsion, which is then sprayed onto the cores.

30. The method as claimed in claim 29, wherein, in the second stage, the flavor ingredients are first made into a solution, then this solution is added to the solution of the material that is to form the matrix.
